(19) United States
(12) Patent Application Publication
(10) Pub. No.: US 2007/0273637 A1
(43) Pub. Date: Nov. 29, 2007

(54) Rail-Stabilized Driving Scheme With Image Memory For An Electrophoretic Display

(75) Inventors: Guofu Zhou, Best (NL); Rogier H.M. Cortie, Ittervoort (NL); Mark T. Johnson, Veldhoven (NL); Leendert M. Hage, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,058

(22) PCT Filed: Mar. 22, 2005
(86) PCT No.: PCT/IB05/50951

§ 371 Date: Sep. 19, 2006

Related U.S. Application Data
(60) Provisional application No. 60/555,115, filed on Mar. 22, 2004.

(51) Int. Cl. G09G 3/34

(52) U.S. Cl. 345/107

(57) ABSTRACT

An image is updated on a bi-stable display (310) such as an electrophoretic display in a transition from a current image state to a subsequent image state. A voltage waveform (600, 620, 640, 660; 700, 720, 740, 760) is selected based on the current and subsequent image states, and a previous image state. The bi-stable display (310) is driven from the current image state to the subsequent image state using the selected voltage waveform. For a given transition from the current to the next image state, different waveforms are stored for different previous states, e.g., black, dark grey, light grey and white. The different waveforms may have different drive pulse (DR) or reset pulse (RE1, RE2) energies. In a trial and error optimization process, different waveforms with different reset and/or drive pulse energies are tested for different previous image states to see which waveform yields the smallest greyscale error.

The invention relates generally to electronic reading devices such as electronic books and electronic newspapers and, more particularly, to a method and apparatus for providing set of driving waveforms for driving a bi-stable display such as an electrophoretic display while improving greyscale accuracy by accounting for an image history of the display.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. The product of the applied voltage and the time duration of the applied voltage is defined as the energy of the drive signal. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in blue liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, a technique is needed for improving greyscale accuracy while maintaining an acceptable image update time.

The invention addresses the above and other issues by providing a method and apparatus for providing set of driving waveforms for driving a bi-stable display such as an electrophoretic display by accounting for an image history of the display.

In a particular aspect of the invention, a method is provided for updating at least a portion of a bi-stable display in a transition from a current image state to a subsequent image state. The method includes: (a) accessing data defining a previous image state that precedes the current image state, (b) accessing data defining at least one voltage waveform according to the previous image state, the current image state, and the subsequent image state, and (c) driving the at least a portion of the bi-stable display from the current image state to the subsequent image state according to the at least one voltage waveform such that the at least a portion of the bi-stable display is driven from the current image state to an optical rail state via at least one reset pulse of the at least one voltage waveform, and subsequently from the optical rail state to the subsequent image state via a driving pulse of the at least one voltage waveform, and an energy of at least a portion of the at least one voltage waveform is set based on the previous image state.

In another aspect of the invention, a method provides at least one voltage waveform for updating at least a portion of a bi-stable display in a transition from a current image state to a subsequent image state. The method includes: (a) providing respective different voltage waveforms for achieving the transition from the current image state, which is preceded by a previous image state, to the subsequent image state, (b) determining respective image errors when driving the at least a portion of the bi-stable display from the previous image state to the current image state, and, using the respective different voltage waveforms, from the current image state to the subsequent image state, and (c) selecting one of the respective different voltage waveforms that is associated with the smallest of the respective image errors for subsequent use in driving the at least a portion of the bi-stable display from the current image state to the subsequent image state after the at least a portion of the bi-stable display is driven from the previous image state to the current image state.

Related electronic reading devices and program storage devices are also provided.

In the drawings:

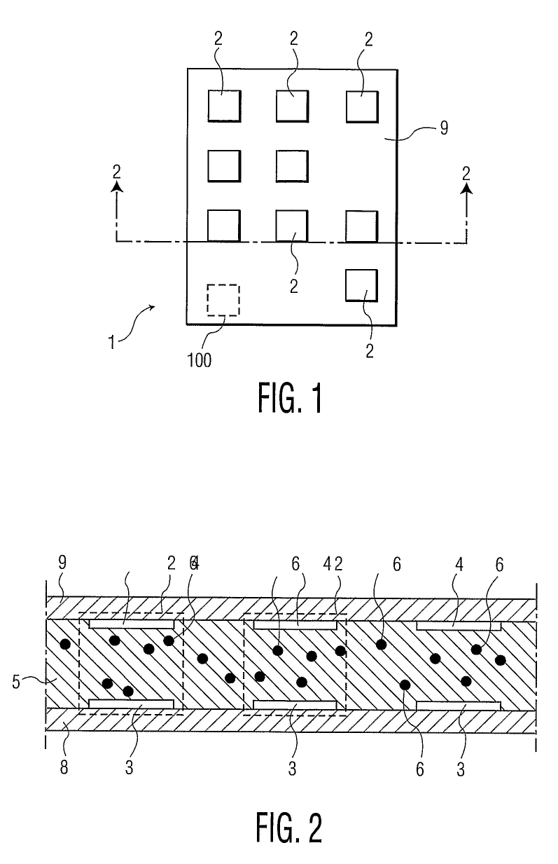

FIG. 1 shows diagramatically a front view of an embodiment of a portion of a display screen of an electronic reading device;

FIG. 2 shows diagramatically a cross-sectional view along 2-2 in FIG. 1;

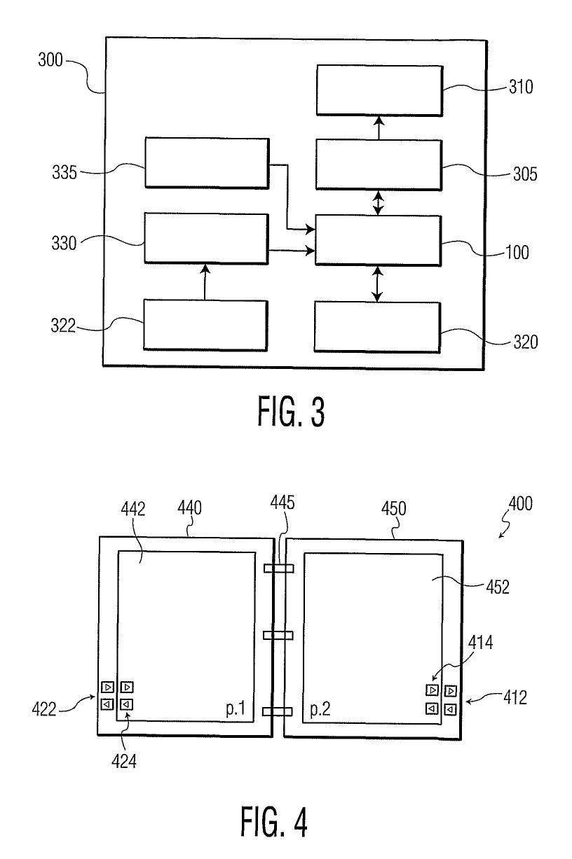

FIG. 3 shows diagramatically an overview of an electronic reading device;

FIG. 4 shows diagramatically two display screens with respective display regions;

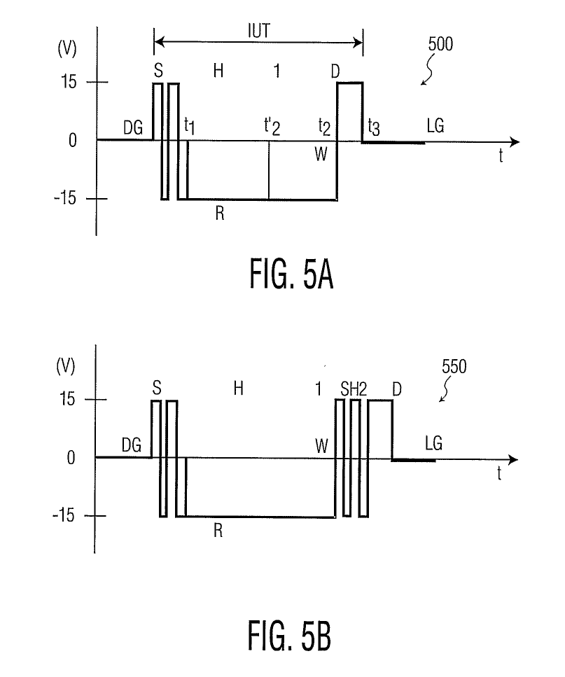

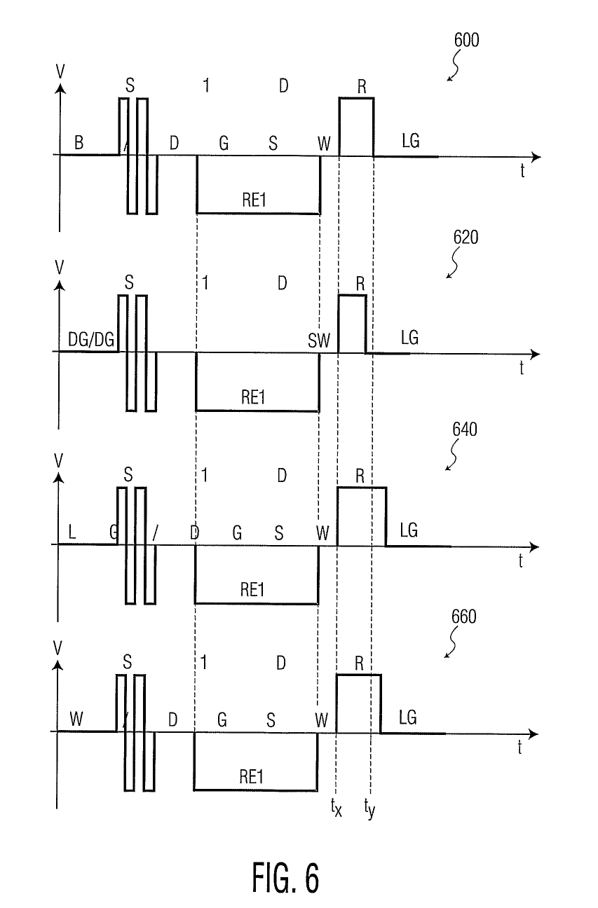

FIG. 5(a) illustrates an example waveform with first shaking pulses for an image transition from dark grey (DG) to light grey (LG) using rail-stabilized driving;

FIG. 5(b) illustrates an example waveform with first and second shaking pulses for an image transition from dark grey (DG) to light grey (LG) using rail-stabilized driving;

FIG. 6 illustrates example waveforms for an image transition from dark grey to light grey, where the prior state is black, dark grey, light grey or white;

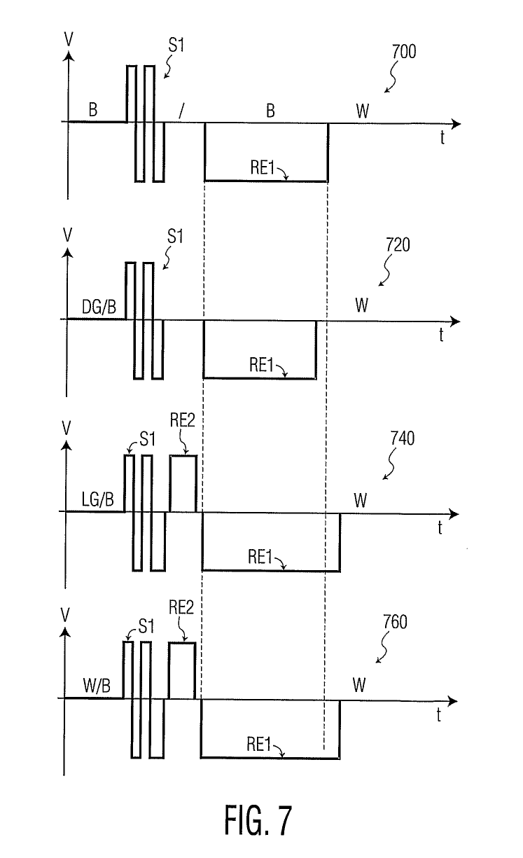

FIG. 7 illustrates example waveforms for an image transition from black to white, where the prior state is black, dark grey, light grey or white;

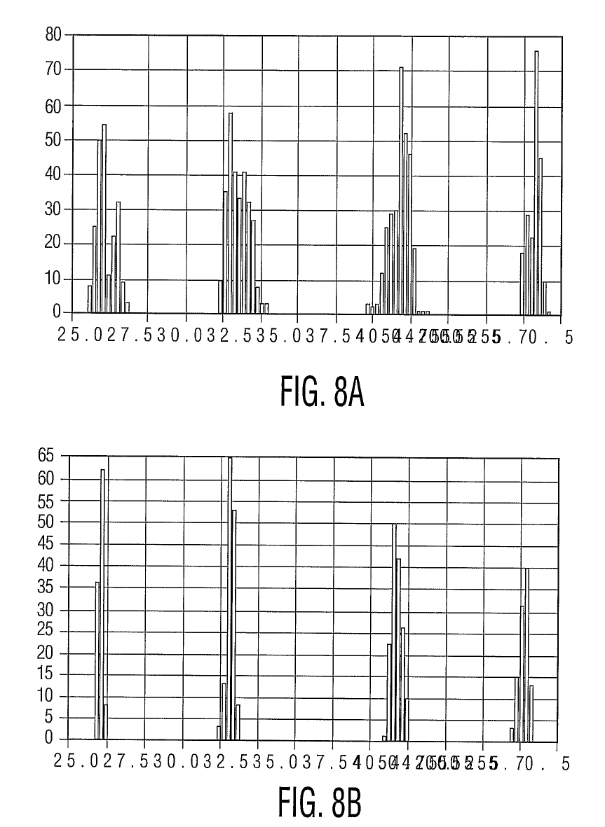

FIG. 8(a) illustrates a histogram indicating greyscale level accuracy when image history is not accounted for;

FIG. 8(b) illustrates a histogram indicating greyscale level accuracy when image history is accounted for; and

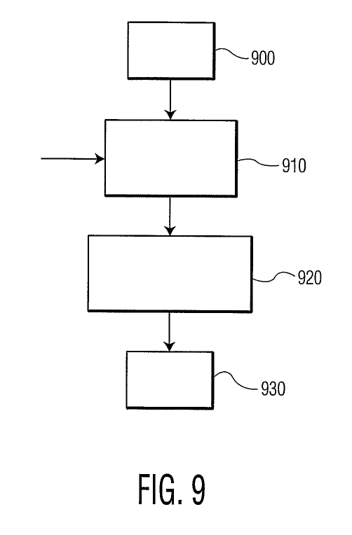

FIG. 9 illustrates an example schematic of a display controller with image memory and the corresponding data processing.

In all the Figures, corresponding parts are referenced by the same reference numerals.

Each of the following is incorporated herein by reference:

European patent application EP 02078823.8, entitled “Electrophoretic Display Panel”, filed Sep. 16, 2002 (docket no. PHNL 020844);

European patent application EP 02079203.2, entitled “Electrophoretic display panel”, filed Oct. 10, 2002 (docket no. PHNL 021000);

European patent application EP 03100133.2, entitled “Electrophoretic display panel”, filed Jan. 23, 2003 (docket no. PHNL 030091);

European patent application EP 02077017.8, entitled “Display Device”, filed May 24, 2002, or WO 03/079323, Electrophoretic Active Matrix Display Device”, published Feb. 6, 2003 (docket no. PHNL 020441); and

European patent application EP 03101705.6, entitled “Electrophoretic Display Unit”, filed Jun. 11, 2003 (docket no. PHNL 030661).

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may act as a voltage source that provides voltage waveforms, via an addressing circuit 305, to the different pixels in the display screen 310. The addressing circuit 305 provides information for addressing specific pixels, such as row and column, to cause the desired image or text to be displayed. The display ASIC 100 causes successive pages to be displayed starting on different rows and/or columns. The image or text data may be stored in a memory 320, which represents one or more storage devices, and accessed by the ASIC 100 as needed. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art. The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 by accessing information stored in the memory 320.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Problem Addressed

One of the major challenges in the research and development of a bi-stable display such as an electrophoretic display is to achieve accurate grey levels, which are generally created by applying voltage pulses for specified time periods. The greyscale accuracy in bi-stable displays such as electrophoretic displays is strongly influenced by image history, dwell time, temperature, humidity, lateral inhomogeneity of the electrophoretic foils and other factors. It has been recently demonstrated that accurate grey levels can be achieved using a rail-stabilized approach. In this approach, the grey levels are always achieved either from the reference black or the reference white state (the two rails). One approach is closest rail driving, as discussed in the above-mentioned European patent application EP 02079203.2 (docket no. PHNL 021000), in which a reset pulse drives the display to the closest rail, e.g., one of the extreme optical states of white or black. Another approach is cyclic rail stabilized driving, in which the display is driven to one of the two rails according to a cyclic pattern.

Furthermore, a driving technique using a single over-reset voltage pulse has been found to be most promising for driving an electrophoretic display, as discussed in the above-mentioned European patent application EP 03100133.2 (docket no. PHNL 030091). In this technique, the pulse sequence usually includes three portions: shaking pulses (SH1), an (over-)reset pulse, and a greyscale driving pulse. It is sometimes desired to apply a second set of shaking pulses (SH2) between the reset and greyscale driving pulses to further eliminate image retention and improving image quality.

This technique is schematically shown in FIG. 5(b) and FIG. 5(c) for an image transition from dark grey (DG) to light grey (LG) via the white (W) rail. In particular, waveform 500 is an example waveform for an image transition from dark grey (DG) to light grey (LG) using first shaking pulses (S1), a reset pulse (R), and a driving pulse (D). Rail-stabilized driving is used. Waveform 550 additionally uses second shaking pulses (S2). The total image update time (IUT) is the sum of the time periods used in each portion of the waveforms. The reset pulse (R) (the time period between t1 and t2), is longer than the minimum time (the time period between t1 and t′2) required for moving the particles from the initial state, e.g., the dark grey position, to the rail state, e.g., the white state, to ensure that the old image is timely erased during a new image update and image quality is guaranteed. The shake pulses (S1) are useful for reducing the dwell time and image history effects, thereby reducing the image retention and increasing greyscale accuracy. The driving pulse (D) is used for adding the grey tones by driving the particles in the display from the rail state, e.g., the white state, to the final optical state, e.g., the light grey state.

The image quality can be largely improved by increasing the over-reset time, e.g., the time period between t′2 and t2. But, the IUT will also be increased. For an e-reading device such as an e-book, the IUT may be limited to within one second or other limit as specified to ensure a satisfactory user experience. In experiments, an IUT of 900 ms has been realized with an acceptable image quality, as demonstrated by a greyscale accuracy of about 2.5-3L*, where L* is luminance, which is related to reflectivity (R) by the expression L*=116*(R/100)ˆ(⅓)−16. However, the greyscale accuracy needs to be largely improved for a larger number of grey levels, for example, sixteen grey levels, to be achieved.

Proposed Solution

The present invention proposes a robust driving method for a bi-stable display such as an electrophoretic display, e.g., having at least a four-bit greyscale, e.g., with 2⁴=sixteen grey levels. Generally, the greyscale accuracy must be sufficient so that the greyscale levels appear distinctly. If the accuracy is not sufficient, the greyscale levels will overlap one another. A voltage waveform including shaking pulses, an over-reset pulse and a greyscale driving pulse is used for driving the display and, for each pixel, at least one prior optical state is considered in selecting a waveform for the next image update. This means that the waveform for the image transition from the current image to the next or other subsequent image is determined by the next or other subsequent state, the current state, and at least one prior optical state. In an experiment that implemented this approach, when one prior optical state is considered, the greyscale accuracy was significantly increased, leading to the feasibility of achieving sixteen grey levels. Moreover, the invention can be implemented without undue burden by providing the necessary memory and processing resources in the electronic reading device. For example, an image memory can be added to the display controller 100 (FIG. 3), and the corresponding data processing can be carried out in the addressing circuit or host controller 330. The memory 320 may also be used for storing the transition matrix including the LUTs with various image histories.

When the next image data is loaded, a waveform is selected according to the current and previous optical states of the pixel. These optical states are stored in the image memory. After completing the next image update, the image memory is refreshed. The old “previous” optical state is removed from the image memory and the old “current” optical state is added to the image memory as the previous state for use in the further new image update. This process is repeated in the further successive image updates.

The waveforms 500 and 550 may be used as the basic voltage waveform platform for driving the display/pixel in one possible approach. However, the invention is generally adaptable for use with any waveform. For example, in a class of waveforms, the reset pulses cause the particles being driven by all waveforms to simultaneously occupy one of the extreme positions corresponding to one of the optical rail states. In general, this occurs in the period before the application of the driving pulses, resulting in a one-bit representation of the following image. The driving pulses thereafter introduce the required grey levels in a natural manner.

As discussed above, although the image quality can be largely improved by increasing the over-reset time (time period between t′2 and t2), this may become impractical at a certain point because the increased IUT can become unacceptably high. Here, we propose to consider at least one prior optical state for each pixel when a waveform is selected for a next image update. Now, the waveform for the image transition from the current image to the next image is determined by the next state, the current state, and prior optical states. This is schematically shown below. W1, W2, W3 and W4 denote different waveforms.

| Previous state: | Current state: | Next state: | Waveform: |
|---|---|---|---|
| B | DG | LG | W1 |
| DG | DG | LG | W2 |
| LG | DG | LG | W3 |
| W | DG | LG | W4 |

The table above is small example transition matrix for a pixel for an image transition from the current image state to the next image state, with one of the four possible prior states. In the example given, the current state is dark grey and the next state is light grey. The four possible previous states are black, dark grey, light grey and white. Moreover, in the present example, only one prior state is considered for each pixel with four possible grey levels. However, the matrix can be adapted for use with other image transitions. For each update request in the new image, a voltage waveform is applied to at least one pixel in the display, where the voltage waveform is a function of at least one prior optical state.

In practice, the table above would be larger to account for each possible image transition and each previous image state. For example, with two bits greyscale, there are sixteen possible transitions. With four possible previous images states for each transition, there are sixty-four possible waveforms needed. However, this may require an undesirable increase in memory capacity. Accordingly, in a further aspect of the invention, the required memory capacity can be reduced by associating a particular waveform with a number of different previous states rather than just one previous state. For example, one waveform could be used for the previous state of B or DG, while another waveform is used for the previous state of LG or W. This can be seen in the table below.

| Previous state: | Current state: | Next state: | Waveform: |
|---|---|---|---|
| B | DG | LG | W1 |
| DG | DG | LG | W1 |
| LG | DG | LG | W2 |
| W | DG | LG | W2 |

If there were sixteen prior states, separate waveforms could be used for the prior states close to white, close to light grey, close to dark grey and close to black, for instance.

Below, example waveforms are illustrated for image transitions from dark grey to light grey (FIG. 6) and from black to white (FIG. 7). Waveforms for other transitions can similarly be provided. Pulse width modulation (PWM) driving is used to illustrate the invention although other driving schemes may be used. Driving schemes using, e.g., closest rail and/or over-reset pulses may be used.

FIG. 6 illustrates example waveforms for an image transition from dark grey to light grey, where the prior state is black, dark grey, light grey or white. The waveforms are plotted showing voltage level (V) as a function of time (t). For example, voltage levels of −15 V, 0V and +15 V may be used. The DG to LG transition is indicated for a prior state of black, dark grey, light grey or white in waveforms 600, 620, 640 and 660, respectively. B/DG, DG/DG, LG/DG and W/DG denote the prior or previous state of black, dark grey, light grey and white, respectively, and the current state of dark grey. S1 denotes shaking pulses. RE1 denotes a first reset pulse. In some cases, a second reset pulse RE2, of opposite polarity to RE1, may be used, as discussed in connection with FIG. 7. SW denotes the substantially white state as a rail state reached via the reset pulse RE1.

The waveforms in FIG. 6 are the same except for the duration/energy of the drive pulses (DR). The drive pulse of waveform 600 extends between times tx and ty. The drive pulse of the waveform 620 is somewhat shorter than that of waveform 600, while the drive pulses of waveforms 640 and 660 are somewhat longer than that of waveform 600. The reset pulse duration and drive pulse duration for the dark grey-to-light grey transitions of FIG. 6 can be summarized as follows:

| Prior State: | Pulse type: | Duration (ms): |
|---|---|---|
| B, DG, LG, W | RE2 | 0 |
| B, DG, LG, W | RE1 | 275 |
| B | DR | 80 |
| DG | DR | 65 |
| LG | DR | 92 |
| W | DR | 90 |

Generally, the prior state effects can be compensated for by varying the impulse energy, which is the pulse time when PWM driving is used, and/or the pulse shape, e.g., a bi-polar or single (uni-)polar pulse shape. The pulse shape may have a varying amplitude, for example, whereas PWM uses a constant amplitude. In FIG. 6, the duration of the driving pulse is varied based on the previous optical state. The relationship between the previous optical state and the duration of the drive pulse (D) cannot be expressed in simple terms. However, the greyscale error can be measured for various trial runs that use with different driving and reset pulse durations and/or energies. The waveform with the driving and reset pulse duration that results in the smallest error can then be selected as being optimal. The waveforms of FIG. 6 are examples of the optimal waveforms for the dark grey to light grey transition

Once the different optimal waveforms for the same image transition with different prior states are experimentally pre-determined, they can be stored in the form of a matrix/look up table (LUT). The proper waveform is then selected in a subsequent update according to the previous state, present state and next state of each pixel in the display.

FIG. 7 illustrates example waveforms for an image transition from black to white, where the prior state is black, dark grey, light grey or white. The B to W transition is indicated for a prior state of black, dark grey, light grey or white in waveforms 700, 720, 740 and 760, respectively. B/B, DG/B, LG/B and W/B denote the prior or previous state of black, dark grey, light grey and white, respectively, and the current state of black. S1 denotes shaking pulses. RE1 and RE2 denote first and second reset pulses, respectively.

The waveforms vary in that waveforms 740 and 760 include the second reset pulse (RE2) while waveforms 700 and 720 do not. The purpose of the second reset pulse (RE2) is to bring the configuration of the particles in the display device to a configuration that is similar to that reached from other prior states, such as from B or DG. Additionally, the duration of the first reset pulse (RE1) is the same or about the same for waveforms 740 and 760, but differs relative to waveforms 700 and 720.

As with the waveforms of FIG. 6, the relationship between the previous optical state and the duration of the drive pulse (D) or reset pulses (RE1, RE2) in FIG. 7 cannot be expressed in simple terms. However, the greyscale error can be measured for various trial runs that are made with different driving pulse durations and/or energies, and different reset pulse durations and/or energies. The waveform with the driving pulse duration and/or energy that results in the smallest error can then be selected as being optimal. The reset pulse duration and drive pulse duration for the black-to-white transitions of FIG. 7 can be summarized as follows:

| Prior State: | Pulse type: | Duration (ms): |
|---|---|---|
| B, DG | RE2 | 0 |
| LG, W | RE2 | 50 |
| B | RE1 | −400 |
| DG | RE1 | −380 |
| LG | RE1 | −420 |
| W | RE1 | −420 |

Similar waveforms can be developed for other transitions. For example, the reset pulse duration and drive pulse duration for the black-to-dark grey transitions can be summarized as follows:

| Prior State: | Pulse type: | Duration (ms): |
|---|---|---|
| B, DG, LG, W | RE2 | 0 |
| B, DG, W | RE1 | 40 |
| LG | RE1 | 20 |
| B | DR | −130 |
| DG | DR | −125 |
| LG, W | DR | −140 |

The reset pulse duration and drive pulse duration for the white-to-light grey transitions can be summarized as follows:

| Prior State: | Pulse type: | Duration (ms): |
|---|---|---|
| B, DG, LG, W | RE2 | 0 |
| B, DG, LG, W | RE1 | 0 |
| B | DR | 55 |
| DG | DR | 65 |
| LG | DR | 55 |
| W | DR | 50 |

Note also that a further set of shaking pulses may be applied during the RE2 or DR, between RE1 and RE2, or between RE1 and DR (see FIGS. 6 and 7). Moreover, the time interval between different pulses may be as short as zero.

FIG. 8(a) illustrates a histogram indicating greyscale level accuracy when image history is not accounted for. FIG. 8(b) illustrates a histogram indicating greyscale level accuracy when image history is accounted for, in accordance with the invention. Representative experimental results are shown using the waveform of FIG. 5(b). The histograms are of four different grey levels as measured on electrophoretic display panels. A count is indicated on the vertical axis, while a reflectivity range (L*) is indicated on the horizontal axis. Four grey levels are created, which are reasonably far from the real dark and/or the real white state. The brightness of the darkest state is about 22L* and for the whitest state is about 65L*. The width of the histogram is proportional to the grey scale error. Thus, a narrower histogram denotes a small error. These four grey levels are clearly separated from each other with a maximum distribution/error of +1.3L* (FIG. 8(b)). In comparison, the grey level error is about +3.0L* with the results in FIG. 8(a). Moreover, the results of FIG. 8(a) are obtained with an IUT of about 900 ms, while the results in FIG. 8(b) are obtained with an improved IUT of about 700 ms. Thus, a better quality and shorter IUT are achieved with the present invention. These results demonstrate that sixteen grey levels can be achieved using the present invention with an IUT of below one second.

FIG. 9 illustrates an example schematic of a display controller with image memory and the corresponding data processing. Block 900 is a temperature sensor that determines an ambient temperature. Block 910 is a controller with image memory that stores the different waveforms and determines which waveform to use for a desired optical transition. A data input represents the desired image to be displayed. Block 920 represents data processing, including selecting the proper waveform W to achieve the desired optical transition. The data processing block 920 includes accessing data via a data input, shown by the arrow pointing to the block 920. The accessed data identifies the previous optical state, the current optical state, and the subsequent optical state, for use in selecting a particular waveform. Block 930 is the display, which is controlled by driving the pixels in the display with the selected waveforms to achieve the desired image.

It has been demonstrated that this invention makes it possible to create a larger number of grey levels because of the improved greyscale accuracy. Four-bit greyscale, with sixteen greyscale levels, is expected to be popular in many bi-stable devices. The capability of achieving sixteen greyscale levels is also important for achieving multi-color electrophoretic displays.

Note that, in the above examples, pulse-width modulated (PWM) driving is used for illustrating the invention, where the pulse time is varied in each waveform while the voltage amplitude is kept constant. However, the invention is also applicable to other driving schemes, e.g., based on voltage modulated driving (VM), where the pulse voltage amplitude is varied in each waveform, or combined PWM and VM driving. The invention is applicable to color as well as greyscale bi-stable displays. Also, the electrode structure is not limited. For example, a top/bottom electrode structure, honeycomb structure, an in-plane switching structure or other combined in-plane-switching and vertical switching may be used. Moreover, the invention may be implemented in passive matrix as well as active matrix electrophoretic displays. In fact, the invention can be implemented in any bi-stable display that does not consume power while the image substantially remains on the display after an image update. Also, the invention is applicable to both single and multiple window displays, where, for example, a typewriter mode exists.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating at least a portion of a bi-stable display in a transition from a current image state to a subsequent image state, comprising:
accessing data defining a previous image state that precedes the current image state;
accessing data defining at least one voltage waveform (600, 620, 640, 660; 700, 720, 740, 760) according to the previous image state, the current image state, and the subsequent image state; and
driving the at least a portion of the bi-stable display (310) from the current image state to the subsequent image state according to the at least one voltage waveform such that the at least a portion of the bi-stable display is driven from the current image state to an optical rail state via at least one reset pulse (RE1, RE2) of the at least one voltage waveform, and subsequently from the optical rail state to the subsequent image state via a driving pulse (DR) of the at least one voltage waveform, and an energy of at least a portion of the at least one voltage waveform is set based on the previous image state.

2. The method of claim 1, wherein:
the at least a portion of the at least one voltage waveform whose energy is set based on the previous image state comprises the at least one reset pulse (RE1, RE2).

3. The method of claim 1, wherein:
the at least a portion of the at least one voltage waveform whose energy is set based on the previous image state comprises the drive pulse (DR).

4. The method of claim 1, wherein:
the driving comprises driving the at least a portion of the bi-stable display such that the at least a portion of the bi-stable display is driven from the current image state to the optical rail state, which is the optical rail state closest to the subsequent image state, via the at least a first reset pulse (RE1, RE2).

5. The method of claim 1, wherein:
the at least one reset pulse (RE1, RE2) causes charged particles in the bi-stable display to simultaneously occupy one of the extreme positions corresponding to one of the optical rail states.

6. The method of claim 1, wherein:
the accessing data defining the at least one voltage waveform comprises accessing data defining the at least one voltage waveform from among data defining a plurality of available voltage waveforms that are associated with the transition from the current image state to the subsequent image state; and
each of the plurality of available voltage waveforms is associated with a respective different previous state.

7. The method of claim 1, wherein:
the accessing data defining the at least one voltage waveform comprises accessing data defining the at least one voltage waveform from among data defining a plurality of available voltage waveforms that are associated with the transition from the current image state to the subsequent image state; and
at least one of plurality of available voltage waveforms is associated with a plurality of different previous states.

8. The method of claim 1, wherein:
the driving comprises driving the at least a portion of the bi-stable display such that a further reset pulse (RE2) of opposite polarity to the at least one reset pulse (RE1), and preceding the at least one reset pulse (RE1), is applied to the at least a portion of the bi-stable display.

9. The method of claim 1, wherein:
the driving comprises driving the at least a portion of the bi-stable display such that shaking pulses (S1) are applied to the at least a portion of the bi-stable display.

10. The method of claim 9, wherein:
the driving comprises driving the at least a portion of the bi-stable display such that the shaking pulses (S1) are applied to the at least a portion of the bi-stable display between the at least one reset pulse (RE1) and the driving pulse (DR).

11. The method of claim 1, wherein:
the at least one reset pulse (RE1, RE2) has an additional reset duration.

12. The method of claim 1, wherein:
the bi-stable display comprises an electrophoretic display.

13. A program storage device tangibly embodying a program of instructions executable by a machine to perform a method for updating at least a portion of a bi-stable display in a transition from a current image state to a subsequent image state, the method comprising:
accessing data defining a previous image state that precedes the current image state;
accessing data defining at least one voltage waveform (600, 620, 640, 660; 700, 720, 740, 760) according to the previous image state, the current image state, and the subsequent image state; and
driving the at least a portion of the bi-stable display (310) from the current image state to the subsequent image state according to the at least one voltage waveform such that the at least a portion of the bi-stable display is driven from the current image state to an optical rail state via at least one reset pulse (RE1, RE2) of the at least one voltage waveform, and subsequently from the optical rail state to the subsequent image state via a driving pulse (DR) of the at least one voltage waveform, and an energy of at least a portion of the at least one voltage waveform is set based on the previous image state.

14. An electronic reading device, comprising:
a bi-stable display (310); and
a control (100) for updating at least a portion of the bi-stable display in a transition from a current image state to a subsequent image state by: (a) accessing data defining a previous image state that precedes the current image state, (b) accessing data defining at least one voltage waveform (600, 620, 640, 660; 700, 720, 740, 760) according to the previous image state, the current image state, and the subsequent image state, and (c) driving the at least a portion of the bi-stable display (310) from the current image state to the subsequent image state according to the at least one voltage waveform such that the at least a portion of the bi-stable display is driven from the current image state to an optical rail state via at least one reset pulse (RE1, RE2) of the at least one voltage waveform, and subsequently from the optical rail state to the subsequent image state via a driving pulse (DR) of the at least one voltage waveform, and an energy of at least a portion of the at least one voltage waveform is set based on the previous image state.

15. A method for providing at least one voltage waveform for updating at least a portion of a bi-stable display in a transition from a current image state to a subsequent image state, comprising:
providing respective different voltage waveforms for achieving the transition from the current image state, which is preceded by a previous image state, to the subsequent image state;
determining respective image errors when driving the at least a portion of the bi-stable display (310) from the previous image state to the current image state, and, using the respective different voltage waveforms, from the current image state to the subsequent image state; and
selecting one of the respective different voltage waveforms (600, 620, 640, 660; 700, 720, 740, 760) that is associated with the smallest of the respective image errors for subsequent use in driving the at least a portion of the bi-stable display (310) from the current image state to the subsequent image state after the at least a portion of the bi-stable display (310) is driven from the previous image state to the current image state.

16. The method of claim 15, wherein:
the providing the respective different voltage waveforms comprises providing the respective different voltage waveforms with reset pulses (RE1, RE2) having different energies.

17. The method of claim 15, wherein:
the providing the respective different voltage waveforms comprises providing the respective different voltage waveforms with drive pulses (DR) having different energies.

18. The method of claim 15, wherein:
the bi-stable display comprises an electrophoretic display.

19. A program storage device tangibly embodying a program of instructions executable by a machine to perform a method for providing at least one voltage waveform for updating at least a portion of a bi-stable display in a transition from a current image state to a subsequent image state, the method comprising:
providing respective different voltage waveforms for achieving the transition from the current image state, which is preceded by a previous image state, to the subsequent image state;
determining respective image errors when driving the at least a portion of the bi-stable display (310) from the previous image state to the current image state, and, using the respective different voltage waveforms, from the current image state to the subsequent image state; and
selecting one of the respective different voltage waveforms (600, 620, 640, 660; 700, 720, 740, 760) that is associated with the smallest of the respective image errors for subsequent use in driving the at least a portion of the bi-stable display (310) from the current image state to the subsequent image state after the at least a portion of the bi-stable display (310) is driven from the previous image state to the current image state.

20. An electronic reading device, comprising:
a bi-stable display (310); and
a control (100) for providing at least one voltage waveform for updating at least a portion of a bi-stable display in a transition from a current image state, which is preceded by a previous image state, to a subsequent image state by: (a) providing respective different voltage waveforms for achieving the transition from the current image state to the subsequent image state, (b) determining respective image errors when driving the at least a portion of the bi-stable display (310) from the previous image state to the current image state, and, using the respective different voltage waveforms, from the current image state to the subsequent image state, and (c) selecting one of the respective different voltage waveforms (600, 620, 640, 660; 700, 720, 740, 760) that is associated with the smallest of the respective image errors for subsequent use in driving the at least a portion of the bi-stable display (310) from the current image state to the subsequent image state after the at least a portion of the bi-stable display (310) is driven from the previous image state to the current image state.
